(19) United States
(12) Patent Application Publication
(10) Pub. No.: US 2010/0290245 A1
(43) Pub. Date: Nov. 18, 2010

(54) ILLUMINATION APPARATUS HAVING HOMOGENIZED RADIATION

(76) Inventor: Günther Nath, Grunwald (DE)

Correspondence Address: BARNES & THORNBURG LLP, 750-17TH STREET NW, SUITE 900, WASHINGTON, DC, 20006-4675, US

(21) Appl. No.: 12/780,018

(22) Filed: May 14, 2010

(30) Foreign Application Priority Data
May 15, 2009 (DE) 10 2009 021 575.1

(51) Int. Cl. G02B 6/00

(52) U.S. Cl. 362/582

(57) ABSTRACT

A liquid light guide 11, 21, 31 which is connected to an irradiation source 23 including a reflector lamp has an irradiation image 12 with a relatively inhomogeneous intensity distribution. The present invention relates to a simple mechanical clamping device to be clamped from outside onto the liquid light guide 11, 21, 31 for impressing a sharp U- or S-shaped curvature thereon. Due to the curvature the intensity distribution of the irradiation image 12 is homogenized at an acceptably low transmission loss of only a few percent.

### BACKGROUND OF THE INVENTION

The present invention relates to an improvement of the homogeneity in the irradiation intensity obtained when using a liquid light guide for transmitting light emanating from an irradiation source having a reflector lamp. A typical example of a liquid light guide known in the prior art is described in DE 42 33 087 A1.

Liquid light guides have a flexible inner tube made of a fluor-carbon-polymer which is filled with liquid. The inner tube is surrounded by a second outer tube which is also flexible. Liquid light guides are typically coupled to irradiation sources, such as tungsten/halogen incandescent lamps, mercury vapor discharge lamps, xenon discharge lamps or light emitting diodes, wherein the lamps are typically cemented in a reflector which has, for example, ellipsoidal form. The incandescent filament or the illuminating plasma of the lamp is located in the first focal point of the reflector, while the light input surface of the liquid light guide is positioned in the second focal point of the reflector. The light cone transmitted by the liquid light guide is emitted at the light output end of the light guide with a round angle divergence of about 60°.

Parabolic or spherical back reflectors may be used instead of the ellipsoidal back reflector. The light irradiated by the lamp is then typically focused by lens systems to the light input surface of the liquid light guide.

The transmission capacity of such liquid light guides in the visible and ultraviolet spectral region is much better than that of light guides made of glass fiber bundles. However, the homogeneity of the irradiation image of the liquid light guide is often dissatisfying, particularly when using the above described commonly used ellipsoidal reflector lamps as irradiation sources, but also when using lamps with other focusing systems for coupling the light into the liquid light guide.

FIG. 1 shows a typical intensity distribution of an irradiation cone 12 emanating from a liquid light guide 11 in a sectional view along the optical axis. In a core region 13 of the irradiation cone 12, one observes a darker zone in which the surface brightness is typically lower by a factor 3 than in the brighter border zone. If the emitted light cone 12 falls onto a screen arranged perpendicular to the light propagating direction, one observes a circular light spot having a ring shaped brighter border and a darker circular area in the centre.

This disadvantageous inhomogeneous irradiation image occurs particularly when using a focusing irradiation system for coupling the light into the liquid light guide. The inhomogeneous irradiation is specifically harmful in applications of the illumination apparatus which require an exact illumination of objects, and for the fluorescent excitation in microscopy or in endoscopy applications.

### SUMMARY OF THE INVENTION

It is an object of the present invention to overcome the above described disadvantages in the prior art and to provide an illumination apparatus having an irradiation image which is as homogeneous as possible.

The object is met by the illumination apparatus defined in the appended independent claims. The dependent claims relate to preferred embodiments.

According to the present invention, the homogeneity of the irradiation image is improved by imposing on the liquid light guide in a section of about 5 to 15 cm of its length a relatively sharp wavelike, particularly U- or S-shaped, curvature, which is maintained by the liquid light guide irrespective of its movements and bendings caused by manipulating the light guide in use. The curvature has in its sharpest curved region a radius between 4 and 8 cm, preferably between 5 and 7 cm, in case of an S-shaped curvature. For a U-shaped bending, the radius of curvature is between 1 and 6 cm, preferable between 2 and 5 cm. The curvature can be obtained from outside by a detachable mechanical clamping device referred to in the following as bending means, or by a permanent thermal deforming of an inner tube of the light guide.

Other aspects and preferred embodiments of the present invention will become apparent from the following detailed description in combination with the drawings.

### BRIEF DESCRIPTION OF THE DRAWINGS

FIG. 1 shows the typical irradiation distribution at the light output end of a liquid light guide without the irradiation homogenisation according to the present invention.

FIG. 2 shows a perspective view of an illumination apparatus according to an embodiment of the present invention.

FIG. 3 shows a top view of a region of the liquid light guide with bending means according to the embodiment of the present invention.

FIG. 4 shows a sectional view along line A-A in FIG. 3.

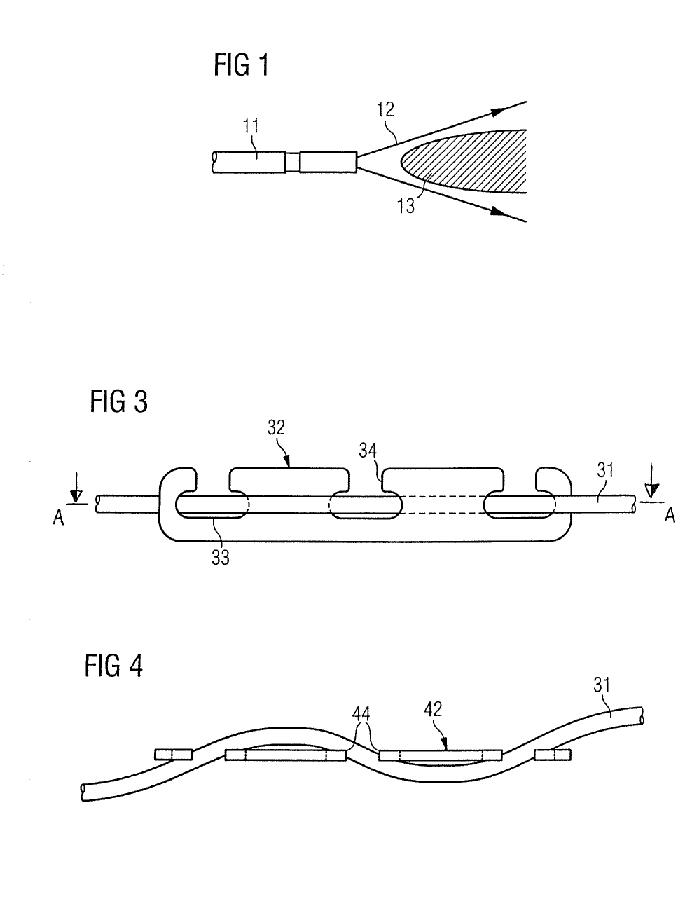

### DETAILED DESCRIPTION OF THE DRAWINGS

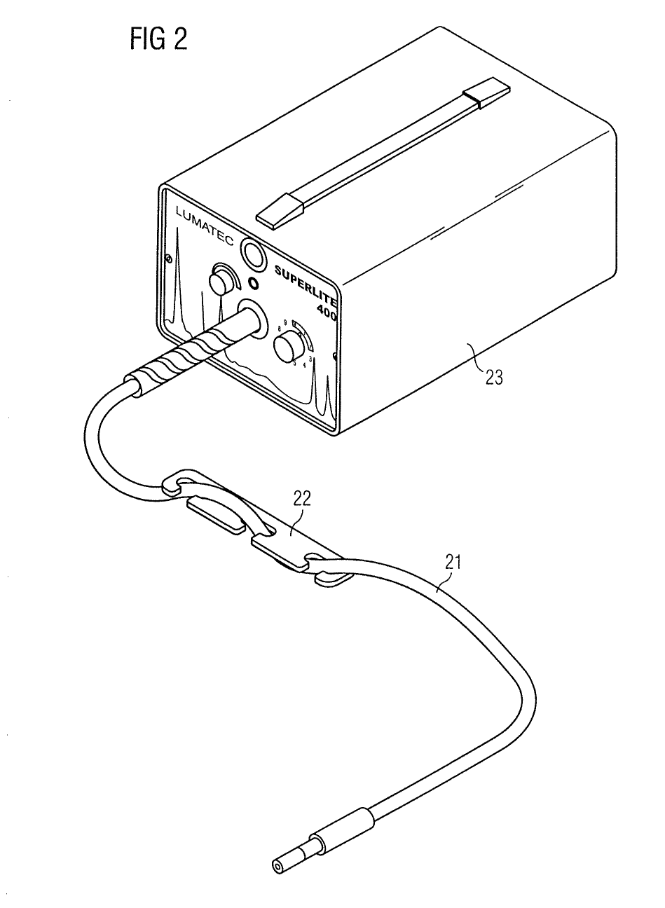

FIG. 2 shows a liquid light guide 21 with impressed S-shaped curvature. The curvature is produced by bending means realized by an elongate rigid plate put onto the liquid light guide. The liquid light guide with impressed curvature is coupled to an irradiation source 23 which includes the reflector lamp described above.

FIGS. 3 and 4 show the geometry of the plate 32, 42 and the extension of the liquid light guide 31 in the plate in further detail. The plate 32, 42 has three openings 33 arranged as elongate holes in the longitudinal axis. Each of the openings 33 comprises an inlet channel 34, 44. Via the inlet channels 34, 44, the liquid light guide can be clamped into the openings 33 so that it obtains an S-shaped curvature due to the rigidity of the plate. The curvature has a limited length and is maintained by the light guide as long as the plate 32, 42 is fixed thereon.

Analogously, a U-shaped curvature can be obtained by using a plate having only two openings (not shown), or by using only two of the three openings 33 of the plate 32, 42.

The impressed S-shaped curvature of the liquid light guide 21, 31 over a length of the light guide which is short in comparison to its complete length does not harm or interfere the application and use of the liquid light guide in practice. But it leads to a substantially improved homogeneity of the irradiation image in the irradiation emitted from the liquid light guide. The transmission loss caused by the impressed curvature can be limited to about 5%. The divergence of the irradiation cone emanating from the liquid light guide 21, 31 increases only by a few degrees which is also acceptable for the user. The inhomogeneity of the surface brightness in the irradiation image varies as a result of the homogenisation only by about 10 to 20% between the core and the border zone.

FIGS. 3 and 4 show in detail the position of the liquid light guide 31 in its clamped position with S-shaped curvature. The inner edges of the plate 32, 42 are slanted on both sides in a fashion which is not illustrated in the drawings. Thereby, the outer protection sleeve of the light guide is not damaged even when the plate is shifted in its clamping position along the light guiding axis.

### BEST MODE OF CARRYING OUT THE INVENTION

In the following, a special, particularly preferable, embodiment is explained in further detail:

A liquid light guide 31 having a light active core of 3 mm diameter is pressed into the plate 32, 42 with the curvature shown in FIG. 4. The liquid light guide 31 including the outer protection tube has an outer diameter of about 7 mm. The plate 32, 42 has a length of 124 mm, a width of 22 mm and a thickness of 3 mm. It is preferably made of a transparent plastics material such as acrylic or polycarbonate. It can also be made of a non-transparent plastics material or metal.

The liquid light guide including its outer protection tube is put into the three lateral inlet channels 34, 44 of the plate, so that it obtains the S-shaped curvature shown in FIG. 4. The width of the inlet channels 34, 44 is 11 mm. Since this width is smaller than the 18 mm long length of the elongate openings 33 having a width of 7 mm, the plate 32, 42 cannot loose itself from the light guide tube 31. The light guide tube is, as a consequence of its sharp S-shaped bending, fixedly clamped to the rigid plate 32, 42.

When using the liquid light guide in operation, the plate hardly interferes the user, because its length of about 124 mm is small compared to the total length of the liquid light guide of typically about 150 cm. Also, the small weight of the plate 32, 42 of only about 6.7 g does not result in any interference of the light guide handling. Moreover, the plate is unobtrusive due to its optical transparency.

In the described example of a liquid light guide having a light active diameter of 3 mm the impressed S-shaped curvature of the light guide tube results in a curvature radius of about 60 mm for each crest.

When using liquid light guides with, for example, 5 mm light active diameter, the dimensions of the plate enlarge only slightly, approximately by a factor between 1.2 and 1.3. When using liquid light guides having a light active diameter of only 2 mm, the dimensions reduce correspondingly.

For reasons of completeness, it is pointed out once more that plates having only two openings (not shown) may also be used. Further, it is also possible to dispose a plurality of plates having two, three or more than three openings after each other or at different positions of the liquid light guide. Particularly, it is possible to twist one of the plates with respect to the other by ca. 90° about the optical axis of the light guide. By using plates having more than three openings, the homogeneity of the irradiation image can be further improved.

According to a further embodiment of the present invention, the curvature of the light guide is impressed not by mechanical means but by permanently deforming a tube of the light guide itself. For example, the light guide tube extending inside of an outer protection tube and filled with the liquid can have a thermally impressed permanent U- or S-shaped curvature. Mechanical means like the above described plate are then unnecessary.

The inner tube which is typically made of Teflon® FEP can be deformed before being filled with the liquid, so that the U- or S-shaped curvature which is desired for the homogenous light irradiation persists permanently. The outer protection tube of the liquid light guide is then put onto the inner tube having the curvature so that the outer protection tube adapts to the curvature of the inner FEP tube. Alternatively, it is also possible to permanently deform the outer protection tube so that the flexible inner tube adapts to the curvature thereof.

The advantage of the external plate 32, 42 fixed onto the protection tube of the liquid light guide in comparison to the most recently described embodiment with the thermally deformed light guide tube resides in that the plate can be arbitrarily attached, detached or shifted. Thereby, the irradiation homogenisation can be enhanced, reduced or completely removed by simple mechanical changes in accordance with the operator's preferences.

What is claimed is:

1. An illumination apparatus comprising an irradiation source and a flexible liquid light guide, characterized by bending means mounted on the liquid light guide, and impressing a curvature thereon.

2. The apparatus of claim 1, wherein the bending means is a dimensionally stable plate which is preferably made of transparent plastics material.

3. The apparatus of claim 1, wherein the bending means comprises a plurality of openings and is clamped onto the liquid light guide which extends through these openings.

4. The apparatus of claim 3, wherein the openings are elongate holes which are preferably arranged along a straight line extending in the longitudinal direction of the elongate holes.

5. The apparatus of claim 3, wherein the bending means comprises two openings, so that it impresses a U-shaped curvature onto the liquid light guide.

6. The apparatus of claim 3, wherein the bending means comprises three openings, so that it impresses an S-shaped curvature onto the liquid light guide.

7. The apparatus of claim 3, wherein the bending element further comprises inlet channels through which the liquid light guide can be put from a side of the bending element into the corresponding openings.

8. The apparatus of claim 7, wherein the inlet channels have a smaller width than the corresponding openings.

9. The apparatus of claim 1, wherein a plurality of said bending means is mounted on the liquid light guide.

10. The apparatus of claim 1, wherein the irradiation source comprises:
a lamp, preferably a tungsten/halogen incandescent lamp, a mercury vapor discharge lamp or a xenon discharge lamp, and
means for focusing the light irradiated from the lamp onto the light input surface of the liquid light guide, wherein the focusing means preferably comprises an ellipsoidal reflector, or a parabolic or spherical reflector in combination with a lens system.

11. An illumination apparatus comprising an irradiation source and a liquid light guide including a light guide tube filled with liquid, characterized in that the material of the light guide tube is deformed so that the liquid light guide has a permanent curvature.

12. The apparatus of claim 11, wherein the light guide tube comprises a fluor-carbon-polymer, preferably Teflon® FEP.

13. The apparatus of claim 11, wherein the light guide tube material is thermally deformed before the tube is filled with the liquid.

14. The apparatus of claim 11, wherein the irradiation source comprises:
a lamp, preferably a tungsten/halogen incandescent lamp, a mercury vapor discharge lamp or a xenon discharge lamp, and
means for focusing the light irradiated from the lamp onto the light input surface of the liquid light guide, wherein the focusing means preferably comprises an ellipsoidal reflector, or a parabolic or spherical reflector in combination with a lens system.
